(19) United States
(12) Patent Application Publication
(10) Pub. No.: US 2026/0149008 A1
(43) Pub. Date: May 28, 2026

(54) POWER GENERATION ELEMENT, POWER GENERATION DEVICE, AND POWER GENERATION METHOD

(71) Applicant: Panasonic Intellectual Property Management Co., Ltd., Osaka (JP)

(72) Inventors: HYUNJEONG NAM, Nara (JP); YUKIHIRO KANEKO, Osaka (JP)

(21) Appl. No.: 19/455,901

(22) Filed: Jan. 22, 2026

Related U.S. Application Data
(63) Continuation of application No. PCT/JP2024/022830, filed on Jun. 24, 2024.

(30) Foreign Application Priority Data
Aug. 8, 2023 (JP) 2023-129404

(51) Int. Cl. H01M 6/36; H01M 4/38; H01M 6/18

(52) U.S. Cl. CPC H01M 6/36; H01M 4/38; H01M 6/185

(57) ABSTRACT

The present disclosure provides an electric power generation element with improved power generation efficiency. An electric power generation element according to the present disclosure includes a first electrode, a second electrode, and a solid electrolyte layer. The first electrode splits water. The solid electrolyte layer is disposed between the first electrode and the second electrode. A resistance value R of the solid electrolyte layer satisfies R<50Ω. The solid electrolyte layer conducts, for example, ions generated by the splitting of water at the first electrode toward the second electrode.

### BACKGROUND

### 1. Technical Field

The present disclosure relates to an electric power generation element, an electric power generation device, and an electric power generation method.

### 2. Description of the Related Art

Conventionally, a thermochemical battery is known as power generation using an electrochemical reaction.

For example, Patent Literature 1 describes a thermochemical battery capable of generating power when there is a temperature difference between a pair of electrodes. In this thermochemical battery, a pair of electrodes are joined to both ends of an electrolyte. At least one of the pair of electrodes is a thin film electrode made of a conductive polymer material. When a temperature difference is applied between the pair of electrodes, the thermochemical battery can generate electric power by using an oxidation-reduction reaction in the vicinity of a joint surface between the electrolyte and each of the pair of electrodes. As the electrolyte, for example, a mixed aqueous solution of K₃[Fe(CN)₆] and K₄[Fe(CN)₆]·3H₂O is used.

Patent Literature 2 describes a thermoelectric conversion material having a redox couple and a capture compound. The capture compound selectively captures only one of the redox couples at low temperatures and releases it at high temperatures. The capture compound is at least one compound selected from the group consisting of cyclic compounds and helical compounds. The thermoelectric conversion material is prepared, for example, as an aqueous solution.

Non-Patent Literature 1 describes an electrochemical thermocell involving a redox reaction of acetone and isopropanol. When the temperature of the electrode on the high-temperature side of the electrochemical thermocell becomes equal to or higher than the boiling point of acetone, acetone is vaporized and flows to the low-temperature side. This reaction achieves a Seebeck coefficient as high as −9.9 mV/K.

### CITATION LIST

### Patent Literature

Patent Literature 1: International Publication No. WO 2018/079325
Patent Literature 2: International Publication No. WO 2017/155046

### Non Patent Literature

Non Patent Literature 1: Hongyao Zhou and Ping Liu, “High Seebeck Coefficient Electrochemical Thermocells for Efficient Waste Heat Recovery,” ACS Appl. Energy Mater. 1 (2018) 1424-1428

### SUMMARY

### Technical Problem

In the technique described in the above document, since a liquid is used, problems associated with leakage and loss of the liquid and drying may occur during use. These problems can give rise to limitations on use, such as reduction in efficiency associated with a reduction in power generation performance, maintenance needs such as replacement of the thermochemical battery, and risks associated with liquid leaks.

An electric power generation element using a solid electrolyte is conceivable from the viewpoint of less restriction on use and maintenance-free. In the study of the present inventors, there is room for improvement in the power generation efficiency of the electric power generation element.

Therefore, the present disclosure provides an electric power generation element with improved power generation efficiency.

### Solution to Problem

An electric power generation element of the present disclosure includes: a first electrode which splits water; a second electrode; and a solid electrolyte layer disposed between the first electrode and the second electrode, wherein a resistance value R of the solid electrolyte layer satisfies R<50Ω.

### Advantageous Effects of Invention

The present disclosure provides an electric power generation element with improved power generation efficiency.

### BRIEF DESCRIPTION OF DRAWINGS

FIG. 1 is a diagram schematically illustrating an example of an electric power generation element of the present disclosure and a power generation principle thereof.

FIG. 2 is a diagram schematically illustrating an example of a thermochemical battery.

FIG. 3 is an exploded perspective view schematically illustrating an example of the electric power generation device of the present disclosure.

FIG. 4 is an exploded perspective view schematically illustrating another example of the electric power generation device of the present disclosure.

FIG. 5 is a graph showing the relationship between the resistance value R and the power density of the electric power generation elements according to Samples 1 to 7.

FIG. 6 is a graph showing the relationship between the cell constant and the power density of the electric power generation elements according to Samples 1 to 7.

### DESCRIPTION OF EMBODIMENTS

### (Findings Underlying the Present Disclosure)

Effective use of energy is required from the viewpoint of CO₂ emission reduction, zero carbon, and carbon neutral. It is conceivable to effectively utilize unused heat generated from factories, automobiles, and living environments. A technique for utilizing such unused heat is also being worked on as a national project and can be an important technique in the future society. For example, in order to convert unused heat into electric energy for effective use, devices in a field called energy harvesting are expected to spread.

As a device that converts heat into electric energy, a thermoelectric conversion element or a thermochemical battery that uses a physical phenomenon such as the Seebeck effect is conceivable. Some thermoelectric conversion elements have already been commercialized. However, in order to convert heat into electric energy using a thermoelectric conversion element, a predetermined temperature difference needs to be generated between both ends of the thermoelectric conversion element. On the other hand, thermochemical batteries are used only for specific applications such as rocket exhaust heat recovery and sodium-sulfur batteries, and further technical development is required from the viewpoint of utilization of unused heat. In addition, when an electrolyte solution is used as an electrolyte in a thermochemical battery, there is a possibility that the amount of the electrolyte solution decreases and the electrolyte solution leaks due to the supply of heat to the thermochemical battery, and it is considered that regular maintenance is required. On the other hand, for example, if it is possible to provide a device that converts heat into electric energy and can be disposed in a place where maintenance is not easy, such as a sealed space, a chimney of a factory, and plant equipment, it is considered that utilization of unused heat can be further promoted.

In view of the above, the present inventors have intensively studied whether or not a novel electric power generation element which is less restricted in use and maintenance-free can be provided. As a result, the present inventors have newly found that an element capable of generating power using water that can be widely present in the environment can be configured. Further, the present inventors have found that there is room for improvement in power generation efficiency of the electric power generation element. Based on these new findings, the present inventors have completed an electric power generation element according to the present disclosure.

### Embodiment of the Present Disclosure

Hereinafter, an embodiment of the present disclosure will be described with reference to the drawings.

FIG. 1 is a diagram schematically illustrating an example of an electric power generation element of the present disclosure and a power generation principle thereof. As shown in FIG. 1, the electric power generation element 1a includes a first electrode 11, a second electrode 12, and a solid electrolyte layer 15. The first electrode 11 splits water. Water may be present in a liquid phase or a gas phase in an environment in contact with the first electrode 11. When water comes into contact with the first electrode 11, the water is split to generate predetermined ions. The predetermined ions are, for example, one kind of ion selected from the group consisting of a proton, an oxide ion, a hydronium ion, and a hydroxide ion. The solid electrolyte layer 15 is disposed between the first electrode 11 and the second electrode 12. The solid electrolyte layer 15 may be in direct contact with the first electrode 11, or a catalyst may be disposed between the solid electrolyte layer 15 and the first electrode 11. The solid electrolyte layer 15 may be in direct contact with the second electrode 12, or a catalyst may be disposed between the solid electrolyte layer 15 and the second electrode 12. The solid electrolyte layer 15 conducts, for example, ions generated by a split of water on the first electrode 11 toward the second electrode 12. A potential difference is generated between the first electrode 11 and the second electrode 12 by the splitting of water on the first electrode 11 and generation of ions in the solid electrolyte layer 15, and an electric current is generated by conduction of the ions. Thus, the electric power generation element 1a supplies electric energy to the outside of the electric power generation element 1a.

In the electric power generation element 1a, the resistance value R of the solid electrolyte layer 15 satisfies R<50Ω. This improves the ion conductivity in the solid electrolyte layer 15 and improves the power generation efficiency of the electric power generation element 1a. More specifically, the value of the power density of the electric power generation element 1a is 2.0×10⁻⁷ W/cm² or more. The solid electrolyte layer 15 has, for example, a first principal surface 15a in contact with the first electrode 11 and a second principal surface 15b in contact with the second electrode 12. The first principal surface 15a and the second principal surface 15b face each other, for example. The “principal surface” means a surface having the largest area of the solid electrolyte layer 15. Specifically, the resistance value R means the resistance value of the solid electrolyte layer 15 in the direction from the first principal surface 15a toward the second principal surface 15b.

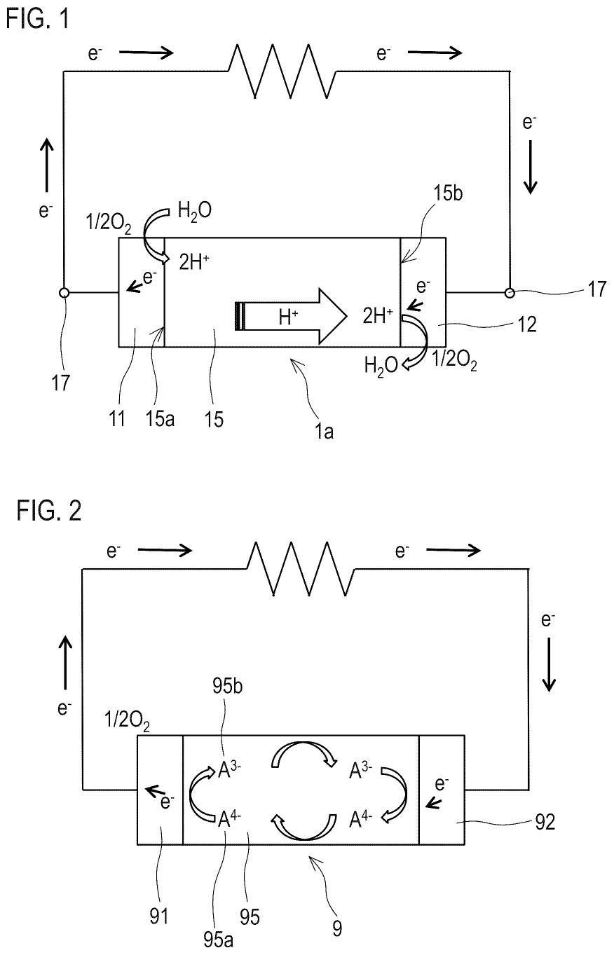

FIG. 2 is a diagram schematically illustrating an example of a thermochemical battery. As shown in FIG. 2, the thermochemical battery 9 includes an electrode 91, an electrode 92, and an electrolyte solution 95. The electrode 91 is an electrode that oxidizes the electrolyte at a high temperature, and the electrode 92 is an electrode that reduces the electrolyte at a low temperature. The electrolyte solution 95 contains first ions 95a and second ions 95b, and the first ions 95a and the second ions 95b have different valences. For example, the first ions 95a are oxidized at the electrode 91 and change to the second ions 95b. The second ions 95b are reduced at the electrode 92 and changed to the first ions 95a. When predetermined heat is supplied to the thermochemical battery 9 and, for example, the temperature of the electrode 91 becomes high, the electrode 91 oxidizes the first ions 95a contained in the electrolyte solution 95 to generate the second ions 95b, and electrons are given to the electrode 91. On the other hand, the electrode 92 receives electrons that have passed through an external circuit connected to the thermochemical battery 9, and reduces the second ions 95b contained in the electrolyte solution 95 to generate the first ions 95a. In the electrolyte solution 95, due to convection and diffusion, the first ions 95a move toward the electrode 91 and the second ions 95b move toward the electrode 92. As a result, oxidation-reduction reactions involving the first ions 95a and the second ions 95b continuously occur, and an electric current is generated in the external circuit. An electromotive force corresponding to a difference in oxidation-reduction potential between the electrode 91 and the electrode 92 at a specific temperature is generated, and an electric current is generated from the electrode 91 having a higher oxidation-reduction potential to the electrode 92 having a lower oxidation-reduction potential. In this case, the thermal energy supplied to the thermochemical battery 9 is consumed by the oxidation-reduction reaction and the diffusion of each ion, and the surplus is extracted as electric energy.

In the thermochemical battery 9, the electrolyte solution 95 is used, and when heat is supplied to the thermochemical battery 9, there is a possibility that the solvent of the electrolyte solution 95 evaporates and the amount of the electrolyte solution 95 decreases. In addition, the electrolyte solution 95 may leak from the thermochemical battery 9. Therefore, the thermochemical battery 9 requires predetermined maintenance. On the other hand, a fluid containing water present outside the electric power generation element 1a is brought into contact with the first electrode 11, thereby allowing the electric power generation element 1a to generate electric power. Therefore, power generation is possible as long as water is present in the environment in contact with the first electrode 11. For example, since a predetermined amount of moisture is always present in the air, the electric power generation element 1a can generate electric power using such moisture. In addition, in the electric power generation element 1a, since ions generated by the splitting of water are conducted using the solid electrolyte, decrease in and leakage of the electrolyte solution do not occur. Therefore, the electric power generation element 1a has few restrictions in use and is advantageous from the viewpoint of maintenance-free.

As described above, the solid electrolyte layer 15 exhibits ion conductivity with respect to ions generated by the splitting of water, for example. The solid electrolyte layer 15 has ion conductivity with respect to, for example, one type of ion selected from the group consisting of a proton, an oxide ion, a hydronium ion, and a hydroxide ion. In the example shown in FIG. 1, the solid electrolyte layer 15 has ion conductivity with respect to protons. Thus, the solid electrolyte layer 15 is, for example, a proton conductor having proton conductivity.

The electric power generation element 1a will be described in more detail with reference to an example in which protons are conducted through the solid electrolyte layer 15. For example, the catalytic activity of the first electrode 11 for water split at the predetermined temperature is higher than the catalytic activity of the second electrode 12 for water split at the predetermined temperature. In this case, the material of the first electrode 11 is different from the material of the second electrode 12, for example. For example, heat can be supplied to the entire electric power generation element 1a so that a temperature difference does not occur between the first electrode 11 and the second electrode 12. In this case, due to the difference in catalytic activity for water split between the first electrode 11 and the second electrode 12, the concentration of protons generated in the first electrode 11 is higher than the concentration of protons generated in the second electrode 12. Heat may be supplied to the electric power generation element 1a so that the temperature of the first electrode 11 is higher than the temperature of the second electrode 12. Also in this case, due to the difference in catalytic activity for water split between the first electrode 11 and the second electrode 12, the concentration of protons generated in the first electrode 11 is higher than the concentration of protons generated in the second electrode 12.

The material of the first electrode 11 may be the same as the material of the second electrode 12. In this case, heat can be supplied to the electric power generation element 1a so that the temperature of the first electrode 11 becomes higher than the temperature of the second electrode 12. In addition, the electric power generation element 1a may be placed in an environment in which heat is supplied to the entire electric power generation element 1a so that a temperature difference does not occur between the first electrode 11 and the second electrode 12, and the concentration of moisture supplied to the first electrode 11 is higher than the concentration of moisture supplied to the second electrode 12. Also in these cases, the concentration of protons generated at the first electrode 11 is higher than the concentration of protons generated at the second electrode 12.

Due to such a difference in proton concentration between the first electrode 11 and the second electrode 12, an electromotive force E according to the following Nernst equation (3) is generated. In addition, protons are diffused in the solid electrolyte layer 15 due to heat and concentration difference, and the protons and oxygen react with each other in the second electrode 12 to generate water vapor. The water vapor diffuses to the outside of the electric power generation element 1a. An electromotive force is generated between the first electrode 11 and the second electrode 12 due to a difference in ion activity, and electrons migrate through an external circuit of the electric power generation element 1a. The heat supplied to the electric power generation element 1a is consumed by the splitting of water on the first electrode 11 and diffusion of protons in the solid electrolyte layer 15. The surplus energy of the chemical energy accompanying the generation of water at the second electrode 12 is extracted as electrical energy.

According to the first law of thermodynamics, the extracted free energy G is defined as in Formula (1) using enthalpy H, thermodynamic temperature T, and entropy S.

$$G = H - T S \qquad Formula ( 1 )$$

The relationship between the extracted free energy G and the electromotive force associated with the cell reaction is expressed by Formula (2). In Formula (2), n is the number of moles of reaction, E₀ is the standard electromotive force, and F is the Faraday constant of 96485 Cmol⁻¹.

$$Δ {G}_{0} = - n {E}_{0} F \qquad Formula ( 2 )$$

The ion activity in the oxidized state and the ion activity in the reduced state in the oxidation-reduction reaction are represented by a_{Ox} and a_{Red}, respectively, thereby allowing the Nernst equation of Formula (3) to be obtained. In Formula (3), E⁰ is the standard electrode potential, R is the gas constant 8.31 JK⁻¹mol⁻¹, T is the absolute temperature, z is the number of transferred electrons, and F is the Faraday constant.

$$E = {E}^{0} + ( RT / zF ) ln ( {a}_{Ox} / {a}_{Red} ) \qquad Formula ( 3 )$$

The electric power generation element 1a can generate electric power using water present in an environment in contact with the first electrode 11 even when ions other than protons generated by the splitting of water are conducted through the solid electrolyte layer 15.

As described above, the electric power generation element 1a is a new electric power generation element in which a thermodynamic phenomenon and an electrochemical principle are combined, using water present in an environment where the electric power generation element 1a is placed as an electrolyte source. By using the electric power generation element 1a, for example, it is possible to obtain electric energy without a necessary temperature difference due to the Seebeck effect. As described above, the electric power generation element 1a can have a configuration A in which the catalytic activity for water split of the first electrode 11 at a predetermined temperature is higher than the catalytic activity for water split of the second electrode 12 at the predetermined temperature. The electric power generation element 1a may have a configuration B in which the first electrode 11 and the second electrode 12 are made of the same material. When the electric power generation element 1a has the configuration A, the electric power generation element 1a can generate electric power even when the water vapor concentration around the electric power generation element 1a is uniform. When the electric power generation element 1a has the configuration B, for example, the electric power generation element 1a can generate electric power by supplying heat to the electric power generation element 1a so that the temperature of the first electrode 11 is higher than the temperature of the second electrode 12. In addition, in the case where the electric power generation element 1a has the configuration B, the electric power generation element 1a can generate electric power also when the concentration of moisture supplied to the first electrode 11 is higher than the concentration of moisture supplied to the second electrode 12.

The water used for the splitting of water on the first electrode 11 of the electric power generation element 1a may be water contained in the atmosphere, may be water present in a sealed space, or may be water derived from humidified air supplied from the outside.

By using the electric power generation element 1a, for example, an electric power generation method including the following (I), (II), (III), and (IV) can be provided.
(I) The electric power generation element 1a is placed in an environment in which water is present, and water is split by the first electrode 11 to generate ions.
(II) Ions generated based on (I) in the solid electrolyte layer 15 are conducted toward the second electrode 12.
(III) The ions generated based on (I) are oxidized or reduced at the second electrode 12 to generate water.
(IV) An electric current is generated outside the electric power generation element 1a.

In the above-described electric power generation method, for example, heat of 500° C. or lower is supplied to the electric power generation element 1a. The temperature of the heat supplied to the electric power generation element 1a may be 400° C. or lower, 350° C. or lower, 300° C. or lower, 250° C. or lower, 200° C. or lower, 150° C. or lower, 100° C. or lower, or 80° C. or lower. The temperature of the heat supplied to the electric power generation element 1a is, for example, 20° C. or higher.

The material of the first electrode 11 is not limited to a specific material as long as it can split water. The first electrode 11 contains, for example, a predetermined metal or alloy. The predetermined metal or alloy includes, for example, at least one selected from the group consisting of Pt, Ag, Pd, Ru, Au, Cu, Ni, Ti, Fe, Cr, Al, W, and Zn. In this case, the first electrode 11 can exhibit high catalytic activity for the splitting of water.

The first electrode 11 may contain an Au—Al alloy, a Pt—Ru alloy, an Ag—Pd alloy, or an Fe—Cr alloy. The Fe—Cr alloy may further contain Ni or Mo. The shape, material, and formation method of the first electrode 11 are not limited to specific shapes, materials, and methods, respectively. The first electrode 11 is obtained by, for example, forming a film of a paste containing a metal or an alloy by printing or coating, and sintering the film. The first electrode 11 may be formed by sputtering, thermal spraying, plating, or pressure bonding.

The first electrode 11 may contain a carbon material. Examples of the carbon material include natural graphite, coke, partially graphitized carbon, carbon fiber, spherical carbon, artificial graphite, and amorphous carbon.

The material of the second electrode 12 is not limited to a specific material. As described above, the material of the second electrode 12 may be the same as or different from the material of the first electrode 11. The material of the second electrode 12 may include, for example, a predetermined metal or alloy. The predetermined metal or alloy includes, for example, at least one selected from the group consisting of Pt, Ag, Pd, Ru, Au, Cu, Ni, Ti, Fe, Cr, Al, W, and Zn.

The second electrode 12 may contain an Au—Al alloy, a Pt—Ru alloy, an Ag—Pd alloy, or an Fe—Cr alloy. The Fe—Cr alloy may further contain Ni or Mo. The shape, material, and formation method of the second electrode 12 are not limited to specific shapes, materials, and methods, respectively. The second electrode 12 is obtained by, for example, forming a film of a paste containing a metal or an alloy by printing or coating, and sintering the film. The second electrode 12 may be formed by sputtering, thermal spraying, plating, or pressure bonding.

The second electrode 12 may contain a carbon material. Examples of the carbon material include natural graphite, coke, partially graphitized carbon, carbon fiber, spherical carbon, artificial graphite, and amorphous carbon.

The solid electrolyte layer 15 is a layer containing a solid electrolyte. The solid electrolyte layer 15 may contain a solid electrolyte as a main component, or may be substantially composed of only a solid electrolyte. The “main component” means a component contained in the solid electrolyte layer 15 in the largest amount in terms of weight ratio. “Consisting essentially of . . . ” means excluding other components that would alter the essential characteristics of the referenced material. However, the solid electrolyte layer 15 may contain impurities in addition to the solid electrolyte.

The solid electrolyte layer 15 includes, for example, at least one selected from the group consisting of an inorganic solid electrolyte or an organic solid electrolyte. When the solid electrolyte layer 15 contains an inorganic solid electrolyte, the electric power generation element 1a is likely to have high durability even when heat is supplied to the electric power generation element 1a. Therefore, there are fewer restrictions on the use of the electric power generation element 1a. The inorganic solid electrolyte may contain at least one selected from the group consisting of water molecules or hydroxide ions.

An example of the inorganic solid electrolyte is a perovskite oxide. The composition of the perovskite oxide is not limited to a specific composition as long as it can conduct ions generated by the splitting of water on the first electrode 11. The perovskite oxide has, for example, a composition represented by BaZr_{1-x-y}CeₓM_{y}O_{3-α}. In this composition, the conditions of 0≤x<0.5 and 0.05≤y≤0.25 are satisfied. In addition, in the composition, M is a trivalent metal element, and a represents the amount of oxygen deficiency. In this case, the ion conductivity of protons in the solid electrolyte layer 15 is likely to increase, and the power generation amount in the electric power generation element 1a is likely to increase.

In the above composition, M is, for example, at least one selected from the group consisting of In, Y, Yb, Gd, Nd, or Sm. In this case, the ion conductivity of protons in the solid electrolyte layer 15 tends to be higher. M may be another trivalent metal element such as La, Pr, Pm, Eu, Tb, Dy, Tm, and Ga.

The perovskite oxide is, for example, a single-phase polycrystal. In the above composition, the oxygen deficiency a is, for example, 0.1 or lower.

The perovskite oxide may have, for example, any one of the following compositions.

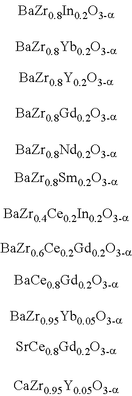

Other examples of inorganic solid electrolytes are minerals. The mineral may be a natural mineral or an artificial mineral. The inorganic solid electrolyte contains, for example, at least one selected from the group consisting of an oxide mineral, a carbonate mineral, a phosphate mineral, or a silicate mineral.

Each of the oxide mineral, the carbonate mineral, the phosphate mineral, and the silicate mineral is not limited to a specific mineral. An example of an oxide mineral is silica gel. In the present specification, an artificially synthesized solid having a composition of an oxide of silicon such as silica gel is classified as an oxide mineral. The basic composition of silica gel is SiO₂·H₂O. An example of a carbonate mineral is hydrotalcite. The basic composition of hydrotalcite is Mg₆Al₂(OH)₁₆CO₃·4H₂O. An example of a phosphate mineral is apatite. The basic composition of apatite is Ca₁₀(PO₄)₆(OH)₂. Examples of silicate minerals are smectite, kaolinite, zeolite F-9, and zeolite A-4. Smectites are swellable silicate minerals. The basic crystal structure of smectite is a structure in which a tetrahedral sheet in which tetrahedrons of (Si, Al)O₄ are two-dimensionally bonded and an octahedral sheet in which hexahedrons of M(O, OH)₆ are two-dimensionally connected in a network form share oxide ions. (Si, Al) means that at least one selected from the group consisting of Si or Al is included, and (O, OH) means that at least one selected from the group consisting of O or OH is included. Examples of M in the octahedral sheet are Al, Mg, Fe, and Ti. Smectite has a layered crystal structure composed of a combination of these two types of sheets. The smectite may be saponite, hectorite, stevensite, or montmorillonite. The basic composition of saponite is (Ca_{0.5}, Na)_{0.33}Mg₃(Si_{3.67}Al_{0.33})O₁₀(OH)₂. The basic composition of stevensite is (Ca_{0.5}, Na)_{0.3}(Mg, Fe)₃Si₄O₁₀(OH)₂. The basic composition of montmorillonite is (Ca_{0.5}, Na)_{0.33}(Al_{1.67}Mg_{0.33})Si₄O₁₀(OH)₂. The basic composition of kaolinite is Al₄Si₄O₁₀(OH)₈. The basic composition of zeolite F-9 is Na₈₆[(AlO₂)₈₆(SiO₂)₁₀₆]·xH₂O. The basic composition of zeolite A-4 is

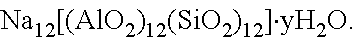

The inorganic solid electrolyte may be a material having a layered crystal structure. In this case, hydration is likely to occur in the solid electrolyte layer 15, and the ion conductivity of the solid electrolyte layer 15 is likely to be higher. For example, in smectite, cations are present between layers, and these cations exhibit very high moisture adsorption. This can increase the ion conductivity of the solid electrolyte layer 15.

The inorganic solid electrolyte is not limited to the above-described materials. The inorganic solid electrolyte may contain a BaCe-based oxide or a CeO₂-based oxide. In this case, the solid electrolyte layer 15 can conduct oxide ions.

The inorganic solid electrolyte may contain phosphate glass, tungsten oxide, or tungstic acid. In this case, the solid electrolyte layer 15 can conduct hydronium ions.

The inorganic solid electrolyte may contain a layered double hydroxide (LDH) containing Mg and Al, or an LDH containing Ni and Al. In this case, the solid electrolyte layer 15 can conduct hydroxide ions.

The inorganic solid electrolyte may be prepared by a solid phase reaction at a high temperature, or may be prepared by sputtering, thermal spraying, or synthesis using an organic intermediate such as alkoxide.

The organic solid electrolyte is a solid electrolyte containing at least one selected from the group consisting of an organic polymer or an organic-inorganic composite polymer, and can conduct ions generated by the splitting of water.

The organic solid electrolyte may have a fluorine-containing polymer containing a fluorine atom, or may have a non-fluorine-containing polymer containing no fluorine atom. Examples of the non-fluorine polymer include polyether ketone, polyether sulfone, polyarylene, and polyimide. Examples of the polyarylene include polyphenylene.

As an example, the organic solid electrolyte includes at least one selected from the group consisting of a fluorine-containing polymer, polyether ketone, polyether sulfone, polyarylene, and polyimide. These polymers may have a sulfonic acid group.

Examples of the fluorine-containing polymer include perfluorosulfonic acid polymers. The perfluorosulfonic acid polymer has a polytetrafluoroethylene (PTFE) unit and a perfluorosulfonic acid unit, and is represented by, for example, the following formula. In the following formula, x, y, m, and n are arbitrary numbers.

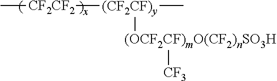

Examples of commercially available products of the perfluorosulfonic acid polymer include Nafion manufactured by DuPont, Flemion manufactured by AGC Inc., and Aciplex manufactured by Asahi Kasei Corporation.

The material of the organic solid electrolyte is not limited to those described above. The organic solid electrolyte may contain a polymer gel. The polymer gel has a network structure formed by crosslinking of a polymer or the like. The polymer gel may further contain a liquid filled in the network structure.

The polymer gel may contain a protic solvent as a liquid. The protic solvent is a solvent containing a hydrogen atom bonded to an oxygen atom or a nitrogen atom. The protic solvent may have a functional group such as a hydroxyl group or an amino group. Examples of protic solvents include water, alcohol, formic acid, hydrogen fluoride, ammonia, hydrochloric acid, sulfuric acid, and nitric acid. A polymer gel comprising water as protic solvent may be referred to as a hydrogel. Examples of hydrogels include gelatin and agar.

The polymer gel may contain an organic liquid as the liquid. Examples of the organic liquid include mineral oil, silicone oil, vegetable oil, and ionic liquid. A polymer gel comprising an organic liquid may be referred to as an organogel.

Examples of the organogel include an organogel in which a network structure of a polymer containing a constituent unit derived from a vinyl monomer is filled with an ionic liquid. Examples of the organogel include an organogel produced by adding methyl methacrylate (MMA) and ethylene glycol dimethacrylate (EGDMA) as a crosslinking agent to 1-ethyl-3-methylimidazolium bis (trifluoromethanesulfonyl) imide (EMIMTFSI) and performing a polymerization reaction.

Other examples of the organogel include an organogel in which a network structure of a crosslinked product of epoxidized cellulose is filled with an ionic liquid. In the organogel, a Brønsted acid ionic liquid or a cellulose-soluble ionic liquid can be used as the ionic liquid.

The polymer gel may be an organic-inorganic composite gel comprising an organic-inorganic composite polymer. Examples of the organic-inorganic composite polymer include a silicone polymer having an organic functional group. The organic functional group may contain a basic group such as an amino group, or may contain an acidic group such as a sulfo group or a phosphoryl group. Examples of the silicone polymer include polysiloxane and polysilsesquioxane.

Examples of the organic-inorganic composite gel include Si_{3/2}(CH₃)NH₂—(HX)ₓ (HX=HClO₄, HCF₃SO₃, HCl, HNO₃, H₃PO₄), polysilsesquioxane having a benzylsulfonic acid group, polyaminopropylsilsesquioxane (PAPS)·xH₂SO₄, an amorphous body formed from 3-glycidoxypropyltrimethoxysilane (GPTMS), polyglycidoxypropylsilsesquioxane (PGPS)—SiO₂—H₃PO₄, 1,8-bis (triethoxysilyloctane) (TES-Oct)/phosphotungstic acid (PWA) hybrid gel, 3-glycidoxypropyltrimethoxysilane (GPTMS)-tetramethoxysilane (TMOS)—H₃PO₄, and GPTMS-cyclohexylethyltrimethoxysilane (EHTMS)—H₃PO₄.

The thickness L of the solid electrolyte layer 15 satisfies, for example, 1.0×10⁻⁶ cm≤L≤0.3 cm. The thickness L may satisfy L≤0.2 cm, L≤0.1 cm, L≤0.05 cm, or L≤0.01 cm. The thickness L may satisfy L≥1.0×10⁻⁵ cm, may satisfy L≥1.0×10⁻⁴ cm, or may satisfy L≥1.0×10⁻³ cm.

In the electric power generation element 1a, the ratio L/S of the thickness L (cm) of the solid electrolyte layer 15 to the area S (cm²) of the surface of the first electrode 11 in contact with the solid electrolyte layer 15 or the surface of the second electrode 12 in contact with the solid electrolyte layer 15 corresponds to the cell constant K. The cell constant K of the electric power generation element 1a satisfies, for example, K≤0.08 cm⁻¹. The cell constant K may satisfy K s 0.075 cm⁻¹, may satisfy K≤0.07 cm⁻¹, may satisfy K≤0.06 cm⁻¹, may satisfy K≤0.05 cm⁻¹, may satisfy K≤0.04 cm⁻¹, or may satisfy K≤0.03 cm⁻¹. The cell constant K may satisfy, for example, K≥0.01 cm⁻¹ or K≥0.02 cm⁻¹. The area of the surface of the first electrode 11 in contact with the solid electrolyte layer 15 is, for example, the same value as the area of the surface of the second electrode 12 in contact with the solid electrolyte layer 15.

As described above, the resistance value R of the solid electrolyte layer 15 satisfies R<50Ω. The resistance value R means the resistance value of the solid electrolyte layer 15 in the direction from the first principal surface 15a toward the second principal surface 15b. The direction from the first principal surface 15a toward the second principal surface 15b is, for example, the thickness direction of the solid electrolyte layer 15. As an example, in a case where the first principal surface 15a and the second principal surface 15b are disposed parallel to each other, the above direction corresponds to a direction perpendicular to the first principal surface and the second principal surface.

The resistance value R can be specified by the following method. First, impedance measurement is performed on the electric power generation element 1a. The impedance measurement can be performed by a two-terminal method using, for example, an LCR meter IM3536 manufactured by Hioki E.E. Corporation. In the impedance measurement, the frequency range is 4 Hz to 8 MHz, the temperature is 30° C., and the humidity is 90 RH %. A Cole-Cole plot is created from the results of the impedance measurement, and a resistance value calculated from the Cole-Cole plot can be regarded as the resistance value R.

As described above, the resistance value R satisfies R<50Ω. The resistance value R may satisfy R≤40Ω, R≤30Ω, or R≤20Ω. The smaller the resistance value R is, the more the ion conductivity in the solid electrolyte layer 15 is improved, and the power generation efficiency of the electric power generation element 1a tends to be improved. The resistance value R may satisfy, for example, R≥1.0×10⁻⁶Ω, R≥1.0×10⁻⁵Ω, R≥1.0×10⁻⁴Ω, R≥1.0×10⁻³Ω, R≥1.0×10⁻²Ω, R≥0.1Ω, R≥1Ω, or R≥10Ω. The resistance value R can be adjusted by, for example, the material of the solid electrolyte layer 15 or the cell constant K of the electric power generation element 1a.

The ion conductivity a of the solid electrolyte layer 15 is not limited to a specific value. The ion conductivity σ satisfies, for example, a condition of σ≥10⁻⁵ Scm⁻¹ at 500° C. or lower. The ion conductivity σ is ion conductivity of ions generated by the splitting of water and conducted through the solid electrolyte layer 15. When such a condition is satisfied, the power generation amount in the electric power generation element 1a is likely to increase. The solid electrolyte layer 15 satisfies, for example, a condition of a 10⁻⁵ Scm⁻¹ at 20° C. or higher. For example, the solid electrolyte layer 15 may satisfy a condition of σ≥10⁻⁵ Scm⁻¹ at 400° C. or lower, may satisfy a condition of σ≥10⁻⁵ Scm⁻¹ at 350° C. or lower, may satisfy a condition of σ≥10⁻⁵ Scm⁻¹ at 300° C. or lower, and may satisfy a condition of σ≥10⁻⁵ Scm⁻¹ at 200° C. or lower.

As shown in FIG. 1, the electric power generation element 1a includes a terminal 17. The terminal 17 is a terminal for supplying electric energy to the outside of the electric power generation element 1a. For example, when an external circuit is electrically connected to the terminal 17, the electric power generation element 1a can supply electric energy to the external circuit.

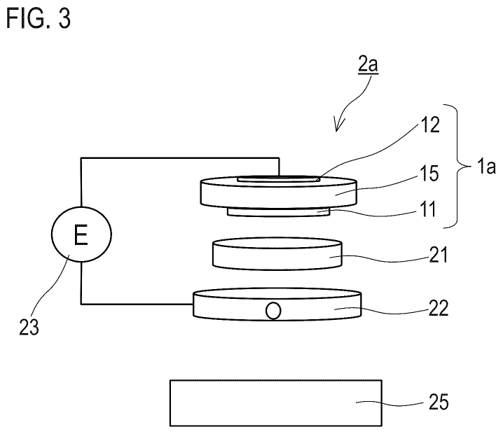

FIG. 3 is an exploded perspective view schematically illustrating an example of the electric power generation device of the present disclosure. As shown in FIG. 3, the electric power generation device 2a includes the electric power generation element 1a and an adsorption/desorption body 21. The adsorption/desorption body 21 communicates with the space around the first electrode 11, and adsorbs or desorbs water vapor according to the temperature. In the electric power generation device 2a, for example, even when the electric power generation element 1a is disposed in a sealed space, the electric power generation element 1a can generate electric power when moisture is supplied from the adsorption/desorption body 21. In the electric power generation device 2a, for example, the adsorption/desorption body 21 contains a predetermined amount of moisture.

The adsorption/desorption body 21 is disposed in contact with the first electrode 11, for example. The first electrode 11 is disposed, for example, between the solid electrolyte layer 15 and the adsorption/desorption body 21. The adsorption/desorption body 21 may be disposed apart from the first electrode 11, and another member may be disposed between the adsorption/desorption body 21 and the first electrode 11.

The material of the adsorption/desorption body 21 is not limited to a specific material as long as water vapor can be adsorbed or desorbed in accordance with the temperature. The adsorption/desorption body 21 includes, for example, at least one selected from the group consisting of silica gel, layered double hydroxide, phosphoric acid hydrate, zeolite, metal felt, or a metal porous body. Accordingly, the adsorption/desorption body 21 can exhibit desired adsorption/desorption characteristics with respect to water vapor. The metal felt is a felt formed of metal fibers. An example of a metal felt is nickel felt. An example of the metal porous body is foamed nickel.

As shown in FIG. 3, the electric power generation device 2a further includes, for example, a cap 22. The cap 22 can accommodate the electric power generation element 1a and the adsorption/desorption body 21. The cap 22 is made of, for example, metal such as stainless steel, and is electrically connected to the first electrode 11. For example, by electrically connecting the cap 22 and the second electrode 12 to a predetermined measurement device 23, the electromotive force and the electric current generated in the electric power generation device 2a can be measured.

As shown in FIG. 3, heat from the heat source 25 is supplied to the electric power generation device 2a. As a result, a high electromotive force is likely to be generated in the electric power generation device 2a.

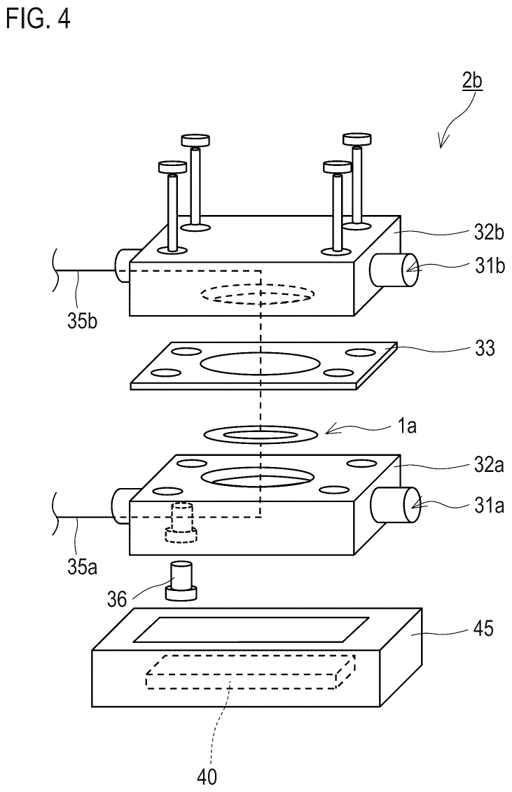

FIG. 4 is an exploded perspective view schematically illustrating another example of the electric power generation device of the present disclosure. As shown in FIG. 4, the electric power generation device 2b includes an electric power generation element 1a and a first supply passage 31a. The first supply passage 31a is a flow path that guides the first fluid containing water to the first electrode 11. The first electrode 11 splits water contained in the first fluid. With this configuration, water contained in the first fluid is split at the first electrode 11, whereby the electric power generation element 1a generates electric energy. The first supply passage 31a is formed so as to be in contact with the first electrode 11, for example. The first fluid does not contain a gas used as a fuel gas in the fuel cell, such as hydrogen gas.

The electric power generation device 2b further includes, for example, a second supply passage 31b. The second supply passage 31b guides, for example, the second fluid containing water to the second electrode 12. Even with this configuration, electric energy can be generated in the electric power generation element 1a. For example, the second supply passage 31b is formed to be in contact with the second electrode 12.

In the electric power generation device 2b, the first fluid has, for example, a first water vapor pressure. The second fluid has, for example, a second water vapor pressure. The first water vapor pressure is different from the second water vapor pressure. For example, the first water vapor pressure is higher than the second water vapor pressure. In other words, the concentration of water vapor in the first fluid is higher than the concentration of water vapor in the second fluid. Therefore, the concentration of protons generated in the first electrode 11 is higher than the concentration of protons generated in the second electrode 12, and electric energy can be generated in the electric power generation element 1a.

As shown in FIG. 4, the electric power generation device 2b includes a flow path member 32a, a flow path member 32b, and a heat resistant insulating sheet 33. A first supply passage 31a is formed inside the flow path member 32a, and a second supply passage 31b is formed inside the flow path member 32b. The heat resistant insulating sheet 33 and the electric power generation element 1a are disposed between the flow path member 32a and the flow path member 32b. An opening is formed on a surface of the flow path member 32a close to the electric power generation element 1a, and the first fluid flowing through the first supply passage 31a can come into contact with the first electrode 11 of the electric power generation element 1a. An opening is formed on a surface of the flow path member 32b close to the electric power generation element 1a, and the second fluid flowing through the second supply passage 31b can come into contact with the second electrode 12 of the electric power generation element 1a. The heat resistant insulating sheet 33 has heat resistance and electrical insulating properties. An opening in contact with the electric power generation element 1a is formed at the center of the heat resistant insulating sheet 33.

The electric power generation device 2b includes, for example, a lead 35a and a lead 35b. The lead 35a is connected to the first electrode 11, and the lead 35b is connected to the second electrode 12. Thus, the electric energy generated in the electric power generation element 1a is supplied to the external circuit.

The electric power generation device 2b further includes, for example, a drain pipe 36. The drain pipe 36 is attached to, for example, the flow path member 32a. Water generated by condensation of water vapor in the flow path member 32a is discharged to the outside of the electric power generation device 2b through the drain pipe 36.

As shown in FIG. 4, a heater 40 is disposed near the electric power generation device 2b. The flow path member 32a and the flow path member 32b are maintained at a predetermined temperature by the heat supplied from the heater 40. A heat insulating material 45 is disposed around the heater 40.

In the electric power generation device 2b, the second electrode 12 may be in contact with the atmosphere. The heat from the heater 40 may be supplied from the first electrode 11 of the electric power generation element 1a, or the entire electric power generation element 1a may be uniformly heated.

### Notes

Based on the above description, the following techniques are disclosed.

### (Technique 1)

An electric power generation element comprising:
a first electrode that splits water;
a second electrode; and
a solid electrolyte layer disposed between the first electrode and the second electrode,
wherein
a resistance value R of the solid electrolyte layer satisfies R<50Ω.

### (Technique 2)

The electric power generation element according to Technique 1, wherein
the solid electrolyte layer conducts ions generated by the splitting of water on the first electrode toward the second electrode.

### (Technique 3)

The electric power generation element according to Technique 1 or 2, wherein
the resistance value R satisfies R≤300.

### (Technique 4)

The electric power generation element according to any one of Techniques 1 to 3, wherein
a thickness L of the solid electrolyte layer satisfies 1.0×10⁻⁶ cm≤L≤0.3 cm.

### (Technique 5)

The electric power generation element according to any one of Techniques 1 to 4, wherein
the solid electrolyte layer has ion conductivity to one kind of ion selected from the group consisting of a proton, an oxide ion, a hydronium ion, or a hydroxide ion.

### (Technique 6)

The electric power generation element according to any one of Techniques 1 to 5, wherein
the solid electrolyte layer includes at least one selected from the group consisting of an inorganic solid electrolyte or an organic solid electrolyte.

### (Technique 7)

The electric power generation element according to Technique 6, wherein
the inorganic solid electrolyte includes at least one selected from the group consisting of an oxide mineral, a carbonate mineral, a phosphate mineral, or a silicate mineral.

### (Technique 8)

The electric power generation element according to any one of Techniques 1 to 7, wherein
a material of the second electrode is different from a material of the first electrode.

### (Technique 9)

The electric power generation element according to any one of Techniques 1 to 8, wherein
the first electrode includes a metal or an alloy including at least one selected from the group consisting of Pt, Ag, Pd, Ru, Au, Cu, Ni, Ti, Fe, Cr, Al, W, or Zn.

### (Technique 10)

The electric power generation element according to any one of Techniques 1 to 9, wherein
the first electrode includes a carbon material.

### (Technique 11)

The electric power generation element according to any one of Techniques 1 to 10, wherein
the first electrode is in contact with a fluid containing water present outside the electric power generation element.

### (Technique 12)

The electric power generation element according to any one of Techniques 1 to 11, further comprising:
a terminal that supplies electric energy to the outside of the electric power generation element.

### (Technique 13)

An electric power generation device, comprising:
the electric power generation element according to any one of Techniques 1 to 12; and
a first supply passage that guides a first fluid containing water to the first electrode,
wherein
the first electrode splits the water contained in the first fluid.

### (Technique 14)

The electric power generation device according to Technique 13, further comprising:
a second supply passage that guides a second fluid containing water to the second electrode,
wherein
the second electrode is in contact with the second fluid.

### (Technique 15)

The electric power generation device of Technique 14, wherein
the first fluid has a first water vapor pressure,
the second fluid has a second water vapor pressure, and
the first water vapor pressure is different from the second water vapor pressure.

### (Technique 16)

An electric power generation device comprising:
the electric power generation element according to any one of Techniques 1 to 12; and
an adsorption/desorption body that communicates with a space around the first electrode and adsorbs or desorbs water vapor depending on temperature.

### (Technique 17)

The electric power generation device according to Technique 16, wherein
the adsorption/desorption body includes at least one selected from the group consisting of silica gel, layered double hydroxide, phosphoric acid hydrate, zeolite, metal felt, or a metal porous body.

### (Technique 18)

An electric power generation method comprising:
placing an electric power generation element including a first electrode, a second electrode, and a solid electrolyte layer disposed between the first electrode and the second electrode in an environment in which water is present, and splitting water by using the first electrode to generate ions;
conducting the ions toward the second electrode in the solid electrolyte layer;
oxidizing or reducing the ions at the second electrode to generate water; and
generating an electric current outside the electric power generation element,
wherein
a resistance value R of the solid electrolyte layer satisfies R<50Ω in the electric power generation element.

### EXAMPLES

Hereinafter, the present disclosure will be described in detail with reference to examples. However, the electric power generation element and the electric power generation method of the present disclosure are not limited to the specific aspects described below.

### <Sample 1>

Purified montmorillonite manufactured by Kunimine Industries Co., Ltd. was placed in a die having an inner diameter of 1 cm. At this time, a Cu electrode and a Pt electrode were arranged so that the montmorillonite was positioned between these electrodes. In this state, pressure was applied using a hydraulic press machine to produce an electric power generation element according to Sample 1. In Sample 1, each of the Cu electrode and the Pt electrode had a disk shape having a diameter of 0.65 cm. A montmorillonite layer as a solid electrolyte layer was formed between the Cu electrode and the Pt electrode. The montmorillonite layer had a first principal surface in contact with the Cu electrode and a second principal surface in contact with the Pt electrode. The thickness L of the montmorillonite layer was 0.009 cm. The area S of the surface of the Cu electrode in contact with the montmorillonite layer was 0.332 cm². In Sample 1, the area of the surface of the Pt electrode in contact with the montmorillonite layer was the same value as the area S of the surface of the Cu electrode.

### <Samples 2 to 7>

Electric power generation elements according to Samples 2 to 7 were produced in the same manner as in the production of the electric power generation element according to Sample 1, except that the thickness L of the montmorillonite layer and the area S of the surface of the Cu electrode in contact with the montmorillonite layer were changed as shown in Table 1. In each sample, the area of the surface of the Pt electrode in contact with the montmorillonite layer was adjusted to the same value as the area S of the surface of the Cu electrode.

### (Evaluation of Resistance Value R)

Impedance measurement was performed on the electric power generation elements according to Samples 1 to 7 under the above-described conditions. The impedance measurement was performed by a two-terminal method using an LCR meter IM3536 manufactured by Hioki E.E. Corporation. A Cole-Cole plot was created from the results of the impedance measurement, and the resistance value was calculated from the Cole-Cole plot and regarded as the resistance value R of the montmorillonite layer.

### (Evaluation of Power Density)

Linear sweep voltammetry (LSV) measurement was performed on the electric power generation elements according to Samples 1 to 7 using an electrochemical analyzer ALS660E. The LSV measurement was performed in an environment of 30° C. and 90 RH %. Thus, an IV curve of each electric power generation element was obtained. The power density was calculated from the obtained IV curve.

TABLE 1

| | | Solid | | Cu | | |
|---|---|---|---|---|---|---|
| | | electrolyte layer | | elec- | Cell | |
| | | Resis- | | trode | con- | |
| | | tance | Thick- | Area | stant | Power |
| | Constitution of | value R | ness L | S | K | density |
| | Elements | [Ω] | [cm] | [cm²] | [cm⁻¹] | [W/cm²] |
| 1 | Cu/Montmorillonite/ | 17 | 0.009 | 0.332 | 0.027 | 11 × 10⁻⁷ |
| | Pt | | | | | |
| 2 | Cu/Montmorillonite/ | 22 | 0.03 | 0.785 | 0.038 | 4.9 × 10⁻⁷ |
| | Pt | | | | | |
| 3 | Cu/Montmorillonite/ | 24 | 0.028 | 0.785 | 0.036 | 6.4 × 10⁻⁷ |
| | Pt | | | | | |
| 4 | Cu/Montmorillonite/ | 35 | 0.045 | 0.785 | 0.057 | 3.8 × 10⁻⁷ |
| | Pt | | | | | |
| 5 | Cu/Montmorillonite/ | 43 | 0.046 | 0.785 | 0.059 | 3.6 × 10⁻⁷ |
| | Pt | | | | | |
| 6 | Cu/Montmorillonite/ | 44 | 0.055 | 0.785 | 0.070 | 2.3 × 10⁻⁷ |
| | Pt | | | | | |
| 7 | Cu/Montmorillonite/ | 50 | 0.061 | 0.785 | 0.078 | 1.4 × 10⁻⁷ |
| | Pt | | | | | |

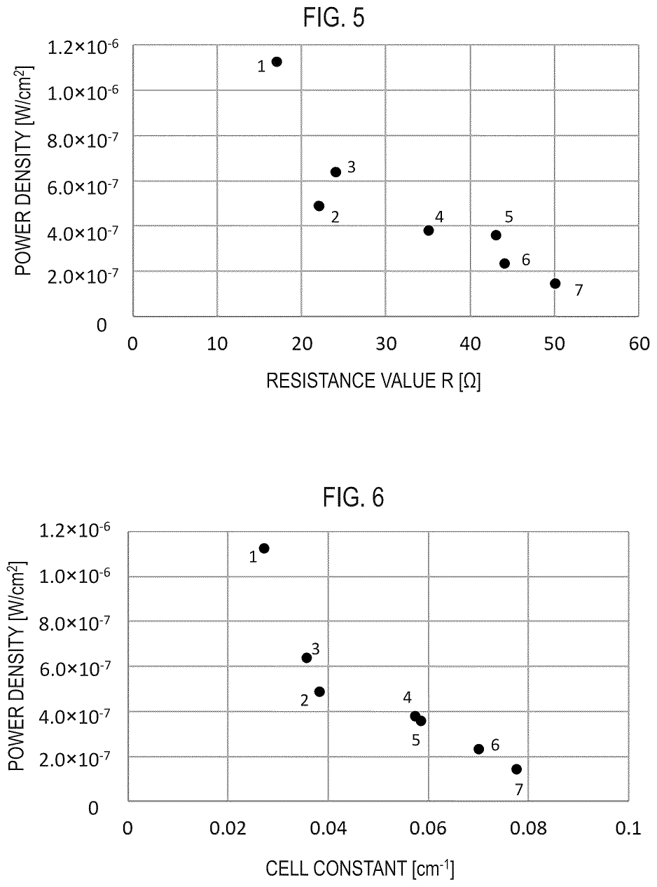

FIG. 5 is a graph showing the relationship between the resistance value R and the power density of the electric power generation elements according to Samples 1 to 7. FIG. 6 is a graph showing the relationship between the cell constant and the power density of the electric power generation elements according to Samples 1 to 7. As can be seen from FIG. 5 and Table 1, in the electric power generation elements according to Samples 1 to 6 in which the resistance value R of the solid electrolyte layer satisfied R<50Ω, the value of the power density was 2.0×10⁻⁷ W/cm² or more, which was higher than that of the electric power generation element according to Sample 7. From this result, it is found that the power generation efficiency is improved in the electric power generation elements according to Samples 1 to 6.

### INDUSTRIAL APPLICABILITY

The electric power generation element of the present disclosure can be used for various applications including applications of conventional electric power generation elements.

### REFERENCE SIGNS LIST

1a Electric power generation element
2a, 2b Electric power generation device
11 First electrode
12 Second electrode
15 Solid electrolyte layer
15a First principal surface
15b Second principal surface
17 Terminal
21 Adsorption/desorption body
31a First supply passage
31b Second supply passage

1. An electric power generation element, comprising:
a first electrode that splits water;
a second electrode; and
a solid electrolyte layer disposed between the first electrode and the second electrode,
wherein
catalytic activity of the first electrode with respect to water splitting at a predetermined temperature is higher than catalytic activity of the second electrode with respect to water splitting at a predetermined temperature; and
a resistance value R of the solid electrolyte layer satisfies R<50Ω.

2. The electric power generation element according to claim 1, wherein
the solid electrolyte layer conducts ions generated by the splitting of water on the first electrode toward the second electrode.

3. The electric power generation element according to claim 1, wherein
the resistance value R satisfies R≤30Ω.

4. The electric power generation element according to claim 1, wherein
a thickness L of the solid electrolyte layer satisfies 1.0×10⁻⁶ cm≤L≤0.3 cm.

5. The electric power generation element according to claim 1, wherein
the solid electrolyte layer has ion conductivity with respect to one kind of ion selected from the group consisting of a proton, an oxide ion, a hydronium ion, or a hydroxide ion.

6. The electric power generation element according to claim 1, wherein
the solid electrolyte layer includes at least one selected from the group consisting of an inorganic solid electrolyte or an organic solid electrolyte.

7. The electric power generation element according to claim 6, wherein
the inorganic solid electrolyte contains at least one selected from the group consisting of an oxide mineral, a carbonate mineral, a phosphate mineral, or a silicate mineral.

8. The electric power generation element according to claim 1, wherein
the first electrode contains a metal or an alloy containing at least one selected from the group consisting of Pt, Ag, Pd, Ru, Au, Cu, Ni, Ti, Fe, Al, W, or Cr.

9. The electric power generation element according to claim 1, wherein
the first electrode contains a carbon material.

10. The electric power generation element according to claim 1, wherein
the first electrode is in contact with a fluid containing water present outside the electric power generation element.

11. The electric power generation element according to claim 1, further comprising:
a terminal that supplies electric energy to the outside of the electric power generation element.

12. An electric power generation device comprising:
the electric power generation element according to claim 1; and
a first supply passage that guides a first fluid containing water to the first electrode,
wherein
the first electrode splits the water contained in the first fluid.

13. The electric power generation device according to claim 12, further comprising:
a second supply passage that guides a second fluid containing water to the second electrode,
wherein
the second electrode is in contact with the second fluid.

14. The electric power generation device according to claim 13, wherein
the first fluid has a first water vapor pressure,
the second fluid has a second water vapor pressure, and
the first water vapor pressure is different from the second water vapor pressure.

15. An electric power generation device comprising:
the electric power generation element according to claim 1; and
an adsorption/desorption body that communicates with a space around the first electrode and adsorbs or desorbs water vapor depending on temperature.

16. The electric power generation device according to claim 15, wherein
the adsorption/desorption body includes at least one selected from the group consisting of silica gel, layered double hydroxide, phosphoric acid hydrate, zeolite, metal felt, or a metal porous body.

17. An electric power generation method comprising:
placing an electric power generation element including a first electrode, a second electrode, and a solid electrolyte layer disposed between the first electrode and the second electrode in an environment in which water is present, and splitting water by using the first electrode to generate ions;
conducting the ions toward the second electrode in the solid electrolyte layer;
oxidizing or reducing the ions in the second electrode to generate water; and
generating an electric current outside the electric power generation element,
wherein
a resistance value R of the solid electrolyte layer satisfies R<50Ω in the electric power generation element.
